(19) United States
(12) Patent Application Publication
(10) Pub. No.: US 2026/0057826 A1
(43) Pub. Date: Feb. 26, 2026

(54) GAMMA VOLTAGE GENERATING CIRCUIT AND DISPLAY DEVICE INCLUDING THE SAME

(71) Applicant: LG Display Co., Ltd., Seoul (KR)

(72) Inventor: Jeong Ho KANG, Paju-si (KR)

(73) Assignee: LG Display Co., Ltd., Seoul (KR)

(21) Appl. No.: 19/258,582

(22) Filed: Jul. 2, 2025

(30) Foreign Application Priority Data
Aug. 23, 2024 (KR) 10-2024-0113348

(51) Int. Cl. G09G 3/3208; G09G 3/32

(52) U.S. Cl. CPC G09G 3/3208; G09G 3/32; G09G 2310/027; G09G 2310/0291; G09G 2320/0276; G09G 2330/021; G09G 2330/028

(57) ABSTRACT

A gamma voltage generating circuit and a display device including the same are discussed. The gamma voltage generating circuit includes a plurality of first buffers to each of which first and second reference voltages are supplied from a power supply, a first resistor string configured to divide the first and second reference voltages applied from the plurality of first buffers, a plurality of second buffers configured to output a plurality of predetermined gamma reference voltages based on divided voltages from the first resistor string, and a second resistor string configured to generate a plurality of predetermined gamma voltages by dividing the gamma reference voltages output from the plurality of second buffers.

### CROSS-REFERENCE TO RELATED APPLICATION

This application claims priority to and the benefit of Korean Patent Application No. 10-2024-0113348, filed in the Republic of Korea on Aug. 23, 2024, the disclosure of which is hereby expressly incorporated by reference in its entirety into the present application.

### BACKGROUND

### Field

The present disclosure relates to a gamma voltage generating circuit and a display device including the same.

### Discussion of the Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, OLEDs are formed in each of pixels. These organic light display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a gate signal, such as a scan signal and emission signal to the display panel, and a data driver that supplies a data signal to the display panel.

### SUMMARY OF THE DISCLOSURE

A data driver can be integrated into at least one integrated circuit (IC), each driver IC includes a gamma voltage generating circuit that generates a gamma voltage, and the gamma voltage generating circuit outputs the gamma voltage via a plurality of gamma buffers. The driving ability of such a gamma buffer is determined by a bias current, and a criterion for setting the bias current is determined based on driving conditions such as a driving voltage and a driving frequency.

However, since the bias current to be applied to a plurality of gamma buffers is set in common, it can be challenging to set a bias current to be applied to each of a plurality of gamma voltage. For example, since the bias current to be applied to a plurality of gamma buffers is fixed in one horizontal line or one frame regardless of the driving conditions, unnecessary current consumption can occur. Accordingly, a method for controlling a bias current that is applied to each gamma buffer is needed.

Accordingly, the present disclosure is directed to solving or addressing all the above-described limitations and problems as well as other disadvantages associated with the related art.

The present disclosure provides a gamma voltage generating circuit and a display device including the same.

It should be noted that objects of the present disclosure are not limited to the above-described objects, and other objects of the present disclosure will be apparent to those skilled in the art from the following descriptions.

A gamma voltage generating circuit according to embodiments of the present disclosure can include a plurality of first buffers to each of which first and second reference voltages are supplied from a power supply; a first resistor string configured to divide the first and second reference voltages applied from the plurality of first buffers; a plurality of second buffers configured to output a plurality of predetermined gamma reference voltages based on divided voltages from the first resistor string; and a second resistor string configured to generate a plurality of predetermined gamma voltages by dividing the gamma reference voltages output from the plurality of second buffers, wherein a bias current with a first magnitude is supplied to at least one of the plurality of first buffers and the plurality of second buffers for a first section of a horizontal period and a bias current with a second magnitude smaller than the first magnitude is supplied to at least one of the plurality of first buffers and the plurality of second buffers for a second section of the horizontal period.

A gamma voltage generating circuit according to embodiments of the present disclosure can include a plurality of first buffers to each of which first and second reference voltages are supplied from a power supply; a first resistor string configured to divide the first and second reference voltages applied from the plurality of first buffers; a plurality of second buffers configured to output a plurality of predetermined gamma reference voltages based on divided voltages from the first resistor string; a second resistor string configured to generate a plurality of predetermined gamma voltages by dividing the gamma reference voltages output from the plurality of second buffers; and a bias part configured to generate a bias current to be applied to the first and second buffers, and wherein the bias part supplies a bias current with a first magnitude to at least one of the plurality of first and second buffers for a first section of a horizontal period and supplies a bias current with a second magnitude smaller than the first magnitude to at least one of the plurality of first and second buffers for a second section of the horizontal period.

A display device according to embodiments of the present disclosure can include a pixel array in which a plurality of data lines, a plurality of gate lines, and a plurality of pixel circuits are disposed; a data driver configured to output a data voltage generated using a gamma voltage to the plurality of data lines; a gate driver configured to output a gate signal to the plurality of gate lines; and a timing controller configured to control the data driver and the gate driver, wherein the data driver includes a gamma voltage generating circuit configured to generate a gamma voltage, wherein the gamma voltage generating circuit includes a plurality of first buffers to each of which first and second reference voltages are supplied from a power supply; a first resistor string configured to divide the first and second reference voltages applied from the plurality of first buffers; a plurality of second buffers configured to output a plurality of predetermined gamma reference voltages based on divided voltages from the first resistor string; a second resistor string configured to generate a plurality of predetermined gamma voltages by dividing the gamma reference voltages output from the plurality of second buffers; and a bias part configured to generate a bias current to be applied to the first and second buffers, and wherein a bias current with a first magnitude is supplied to the plurality of first and second buffers for a first section of a horizontal period and a bias current with a second magnitude smaller than the first magnitude is supplied to the plurality of first and second buffers for a second section of the horizontal period.

A display device according to embodiments of the present disclosure can include a pixel array in which a plurality of data lines, a plurality of gate lines, and a plurality of pixel circuits are disposed; a data driver configured to output a data voltage generated using a gamma voltage to the plurality of data lines; a gate driver configured to output a gate signal to the plurality of gate lines; and a timing controller configured to control the data driver and the gate driver, wherein the data driver includes a gamma voltage generating circuit configured to generate a gamma voltage, wherein the gamma voltage generating circuit includes a plurality of first buffers to each of which first and second reference voltages are supplied from a power supply; a first resistor string configured to divide the first and second reference voltages applied from the plurality of first buffers; a plurality of second buffers configured to output a plurality of predetermined gamma reference voltages based on divided voltages from the first resistor string; a second resistor string configured to generate a plurality of predetermined gamma voltages by dividing the gamma reference voltages output from the plurality of second buffers; and a bias part configured to generate a bias current to be applied to the first and second buffers, and wherein the bias part includes n (where n is a natural number greater than one) transistors each having a gate electrode to which the generated bias current is applied, a first electrode connected to the first and second buffers, and a second electrode connected to a power line to which a low-potential voltage is applied; and m (where m is a natural number) switches connected between the gate electrodes of the n transistors.

According to the present disclosure, current consumption can be reduced by adjusting a driving current of a gamma buffer in the gamma voltage generating circuit according to a load of the display panel or adjusting the bias current applied to the gamma buffer according to an output voltage of the gamma buffer.

According to the present disclosure, since current consumption can be reduced, low-power driving can be performed.

The effects of the present specification are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram illustrating a display device according to one or more embodiments of the present disclosure;

FIG. 2 is a diagram illustrating a configuration of a data driver according to the embodiment of the present disclosure;

FIG. 3 is a diagram illustrating a data packet;

FIG. 4 is a diagram illustrating a configuration of a gamma voltage generating circuit illustrated in FIG. 2;

FIG. 5 is a diagram illustrating a detailed configuration of a buffer part according to a first embodiment of the present disclosure;

FIGS. 6 to 9 are diagrams illustrating a bias current adjustment principle for adjusting a bias current;

FIG. 10 is a diagram illustrating a detailed configuration of a first buffer part according to a second embodiment of the present disclosure;

FIGS. 11A, 11B, and 12 are diagrams illustrating an operation principle of a first buffer for comparison;

FIG. 13 is a diagram illustrating a detailed configuration of a second buffer part according to a third embodiment of the present disclosure;

FIG. 14 is a diagram illustrating a detailed configuration of a second buffer part according to a fourth embodiment of the present disclosure; and

FIGS. 15A, 15B, and 16 are diagrams illustrating an operation principle of a second buffer for comparison.

### DETAILED DESCRIPTION OF THE EMBODIMENTS

Advantages and features of the present specification and methods of achieving them will become apparent with reference to preferable embodiments, which are described in detail, in conjunction with the accompanying drawings. However, the present specification is not limited to the embodiments to be described below and can be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only examples, the present disclosure is not limited to the illustrated items. The same reference numerals indicate the same components throughout the specification. Further, in describing the present disclosure, when it is determined that a detailed description of related known technology can unnecessarily obscure the gist of the present disclosure, the detailed description thereof will be omitted.

When ‘including,’ ‘having,’ ‘consisting,’ and the like mentioned in the present specification are used, other parts can be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts can be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below can also be a second component within the technical spirit of the present disclosure. Further, the term “can” fully encompasses all the meanings and coverages of the term “may” and vice versa.

The same reference numerals can refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings. All the components of each display device according to all embodiments of the present disclosure are operatively coupled and configured.

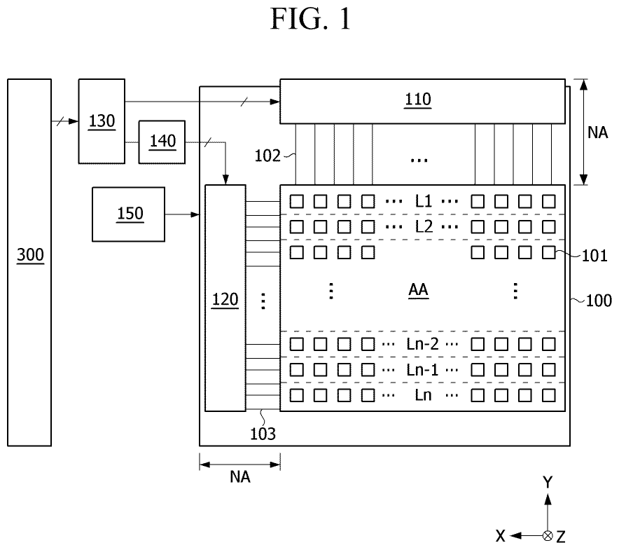

FIG. 1 is a block diagram illustrating a display device according to one or more embodiments of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 can be, but not limited to, a panel having a rectangular structure with a length in an X-axis direction, a width in a Y-axis direction, and a thickness in a Z-axis direction. For example, the display panel 100 can be a heterogeneous panel of which at least a portion is curved or elliptical.

The display area AA (or active area) of the display panel 100 includes a pixel array to display an input image. The pixel array includes a plurality of data lines 102, a plurality of gate lines 103 crossing the data lines 102, and pixels arranged in a matrix form. The display panel 100 can further include power lines commonly connected to the pixels. The power lines can be commonly connected to pixel circuits to supply a voltage needed for driving pixels 101 to the pixels 101.

Each of the pixels 101 can be divided into a red sub-pixel, a green sub-pixel, and a blue sub-pixel for color implementation. Each pixel can further include a white sub-pixel. Each sub-pixel includes a pixel circuit for driving a light emitting element. The light emitting element can include an OLED or an inorganic light emitting diode (LED). Each pixel circuit is connected to the data lines, the gate lines, and the power lines. In the following description, a pixel can be interpreted as a sub-pixel.

The display area AA includes a plurality of pixel lines LI to Ln. Each of the pixel lines LI to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines LI to Ln.

The display panel 100 can be implemented with a non-transmissive display panel or a transmissive display panel. The transmissive display panel can be applied to a transparent display device in which an image is displayed on the screen and a real object in the background is visible. The display panel 100 can be made of a flexible display panel.

The power supply 150 receives an input voltage applied from the host system 300 and outputs a voltage needed to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage can be supplied to the level shifter 140 and the gate driver 120. Voltages such as pixel driving voltage, cathode voltage, and reference voltage can be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit can further include a touch sensor driver for driving touch sensors. The data driver 110 and the touch sensor driver can be integrated into one source drive IC.

The data driver 110 receives pixel data of the input image as a digital signal from the timing controller 130 and outputs a data voltage. The data driver 110 can receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data can include mode selection data for selecting first mode and second mode. The DAC converts the pixel data into a gamma compensation voltage and outputs a data voltage of the pixel data.

The gate driver 120 can be formed on the display panel 100 together with the circuit elements and wiring lines of the display area AA. The gate driver 120 can be disposed in at least one of left and right non-display areas NA (or non-active areas) outside the display area AA in the display panel 100 or at least a part thereof can be disposed within the display area AA.

The gate driver 120 sequentially outputs pulses of the gate signals to the gate lines 103 under the control of the timing controller 130. The gate driver 120 can sequentially supply the gate signals to the gate lines 103 by shifting the pulses of the gate signals.

The timing controller 130 receives digital video data of an input image and a timing signal synchronized with this data from the host system 300. The timing signal can include a vertical synchronization signal Vsync, a horizontal synchronization signal Hsync, and a data enable signal DE. Since the vertical period and horizontal period can be known by counting the data enable signal DE, the vertical synchronization signal Vsync and the horizontal synchronization signal Hsync can be omitted. The horizontal synchronization signal Hsync and the data enable signal DE have a periodicity of 1 horizontal period (1H).

The timing controller 130 can control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 can synchronize the data driver 110 and the gate driver 120 by controlling the operation timing of the display panel driving circuit.

The gate timing control signal output from the timing controller 130 can be input to the shift register of the gate driver 120 through the level shifter 140. The level shifter 140 can convert a voltage of the gate timing control signal received from the timing controller 130 to a swing width between the gate-on voltage and the gate-off voltage and supply it to the gate driver 120.

The host system 300 can include a main board of one of a television system, a set-top box, a navigation system, a personal computer (PC), a vehicle system, a mobile terminal, and a wearable terminal. The host system 300 can scale an image signal from a video source according to the resolution of the display panel 100, and can transmit it to the timing controller 130 together with the timing signals.

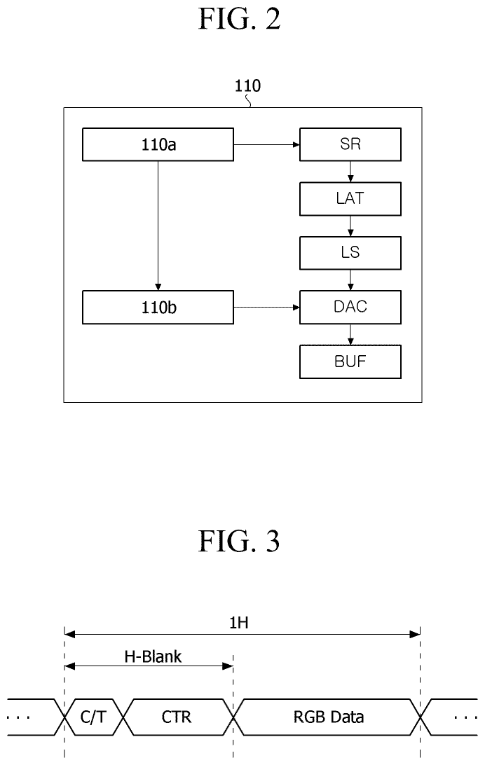

FIG. 2 is a diagram illustrating a configuration of a data driver according to the embodiment of the present disclosure, and FIG. 3 is a diagram illustrating an example of a data packet.

Referring to FIG. 2, a data driver 110 according to the embodiment of the present disclosure can include a control circuit 110a, a gamma voltage generating circuit 110b, a shift register SR, a latch LAT, a DA converter DAC, and a buffer part BUF. The data driver 110 can further include a level shifter LS.

The control circuit 110a can control a driving current or a bias current of a gamma buffer in the gamma voltage generating circuit 110b on the basis of a data packet transmitted from a timing controller.

Referring to FIG. 3, the data packet can include clock training data C/T, control data CRT, and pixel data RGB Data. The control data can include at least one of first power control information GPWRC for determining sections where different bias currents are to be applied for every horizontal period, second power control information SGC for controlling a bias current to be applied to a gamma buffer, and third power control information D_SEL for controlling a driving current of the gamma buffer.

In this case, the first to third power control information can have two bits and can include four pieces of information. For example, the first to third power control information can include HH, HL, LH, and LL. While a case where the first to third power control information have two bits has been described as an example, the present disclosure is not limited thereto.

The gamma voltage generating circuit 110b can generate gamma voltages and can provide the generated gamma voltages to the DA converter DAC.

The shift register SR can shift a clock input from the timing controller to generate a sampling clock, and can sequentially output the generated sampling clock to the latches LAT.

The latches LAT can sample and store pixel data of the input image according to the timing of the sequentially input sampling clock, and can simultaneously output the stored pixel data.

The level shifters LS can convert the voltage level of the stored pixel data. The level shifters LS can convert the voltage level of the pixel data into a voltage level that can drive the DA converters DAC.

The DA converters DAC can convert the pixel data output from the latches LAT or the pixel data whose voltage level has been converted by the level shifters LS into an analog form.

The buffer part BUF can amplify the voltage level of the pixel data in analog form, and can output the pixel data with the amplified voltage level to the corresponding data lines through the output terminals.

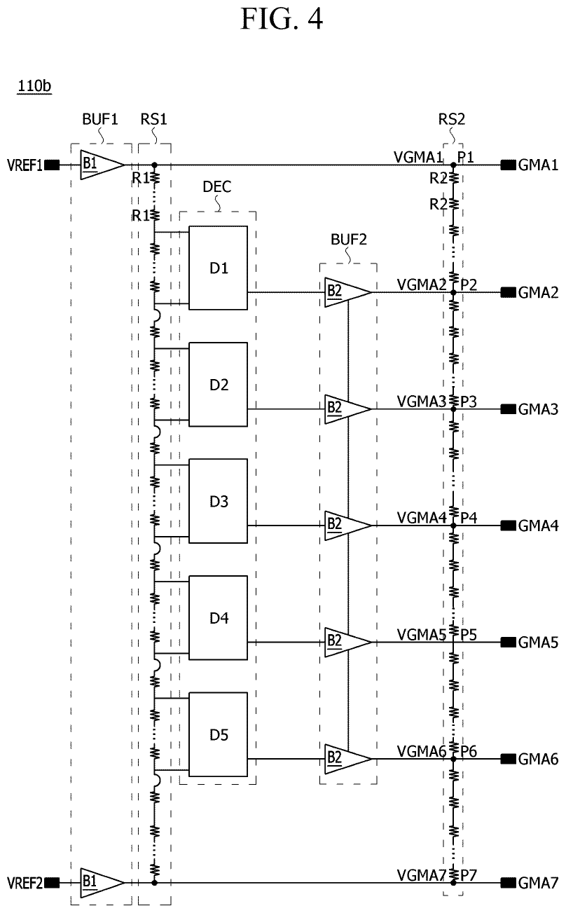

FIG. 4 is a diagram illustrating a configuration of a gamma voltage generating circuit illustrated in FIG. 2.

Referring to FIG. 4, the gamma voltage generating circuit 110b according to the embodiment of the present disclosure can include a first buffer part BUF1, a first resistor string RS1, a decoder part DEC, a second buffer part BUF2, and a second resistor string RS2.

The first buffer part BUF1 can include a plurality of first gamma buffers or first buffers B1. The plurality of first buffers B1 can apply reference voltages VREF1 and VREF2 supplied from a power supply to predetermined nodes of the first resistor string RS1. A first buffer B1 can include an input terminal connected to the power supply and an output terminal connected to one end of the first resistor string RS1. Another first buffer B1 can include an input terminal connected to the power supply and an output terminal connected to the other end of the first resistor string RS1.

The first resistor string RS1 can include a plurality of first resistors R1. The plurality of first resistors R1 can be connected in series and can have the same resistance value, but are not limited thereto.

The decoder part DEC can include a plurality of decodes D1, D2, D3, D4, and D5. The decoder part DEC can convert divided voltages from the first resistor string RS1 into gamma reference voltages VGMA2, VGMA3, VGMA4, VGMA5, and VGMA6 and can output the gamma reference voltages VGMA2, VGMA3, VGMA4, VGMA5, and VGMA6.

The second buffer part BUF2 can include a plurality of second gamma buffers or second buffers B2. The plurality of second buffers B2 can apply the gamma reference voltages applied to the decoder part DEC, to predetermined nodes of the second resistor string RS2.

The second resistor string RS2 can include a plurality of second resistors R2. The plurality of second resistors R2 can be connected in series and can have the same resistance value, but are not limited thereto. The second resistor string RS2 can divide the gamma reference voltages applied to the predetermined nodes to generate gamma voltages GMA1, GMA2, GMA3, GMA4, GMA5, GMA6, and GMA7 and can output the generated gamma voltages GMA1, GMA2, GMA3, GMA4, GMA5, GMA6, and GMA7. The gamma voltage GMA1, GMA2, GMA3, GMA4, GMA5, GMA6, and GMA7 can be supplied to the DA converter.

In the embodiment, while a case where a single gamma voltage generating circuit is used has been described as an example, the present disclosure is not necessarily limited thereto. For example, the gamma voltage generating circuit can be implemented to a positive polarity (+) gamma voltage generating circuit and a negative polarity (−) gamma voltage generating circuit.

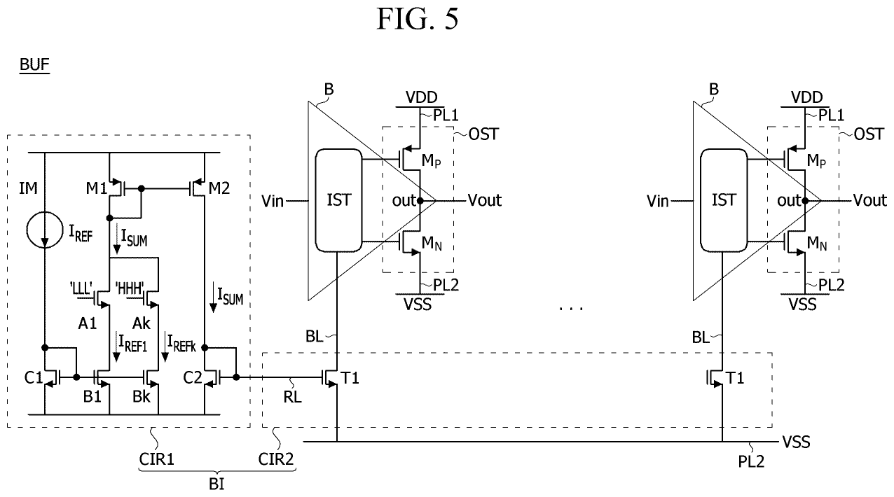

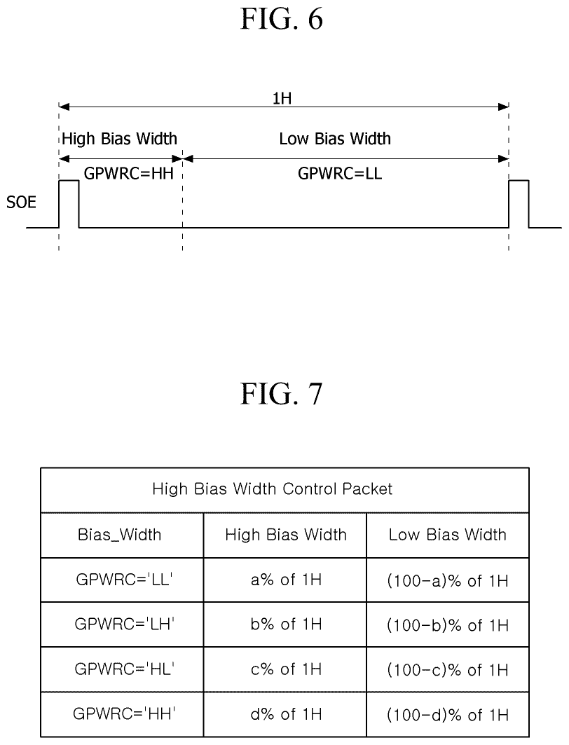

FIG. 5 is a diagram illustrating a detailed configuration of a buffer part according to a first embodiment of the present disclosure, and FIGS. 6 to 9 are diagrams illustrating a bias current adjustment principle for adjusting a bias current.

Referring to FIG. 5, a buffer part BUF according to a first embodiment of the present disclosure can include a bias part BI and buffers B. Here, the buffer part BUF can include the first buffer part BUF1 and the second buffer part BUF2 in the gamma voltage generating circuit 110b, and the first and second buffer parts BUF1 and BUF2 can have the same configuration. The bias part BI can be applied in common to the first and second buffer parts BUF1 and BUF2.

The bias part BI can include a first circuit part CIR1 and a second circuit part CIR2 that output a bias current on the basis of a reference current generated in a current source IM.

The first circuit part CIR1 can generate a bias current with a predetermined magnitude according to the first power control information GPWRC. For example, when the first power control information GPWRC is ‘LL’, a transistor A1 can be turned on, and Isum=Iref. When the first power control information GPWRC is ‘HH’, a transistor Ak can be turned on, and Isum=a×Iref (for example, Isum=4×Iref). The reason is that the transistors A1 to Ak in a current mirror circuit are designed to have different channel capacities.

The second circuit part CIR2 can apply the bias current to each first buffer B1. The second circuit part CIR2 can include a transistor T connected to each first buffer B1.

A first transistor T1 can be turned on with the application of the bias current generated by the first circuit part CIR1 as a gate current to apply a bias current to the corresponding buffer B.

In the embodiment, as in FIG. 6, the bias current of the buffers B will be adjusted for one horizontal period (1H) using the first power control information GPWRC. For example, the bias part B according to the embodiment can apply a bias current with a first magnitude for a first section having a predetermined ratio and can apply a bias current with a second magnitude smaller than the first magnitude for a second section having a remaining ratio, with a rising time of source output enable (SOE) as a reference.

In this case, the first power control information GPWRC can be set in advance according to a load of the display panel. Here, the load of the display panel can include characteristic values that can be different due to deviation in the manufacturing process of the display panel, for example, a resistance value and capacitance, but is not limited thereto. Since an output voltage of the buffer for every display panel is different depending on the load of the manufactured display pane, the first power control information GPWRC can be set to be different according to the output voltage. For example, the ratio can be determined large when the display panel is manufactured to have a large load, and the ratio can be determined small when the display panel is manufactured to have a small load. Accordingly, if the first power control information GPWRC is used, the bias current of the buffers in the display panels having different loads can be easily adjusted.

Referring to FIG. 7, when the first power control information GPWRC is ‘LL’, a first bias current can be applied to the buffers for a first section having a ratio a of 1H, and a second bias current can be applied to the buffers for a second section having a ratio (100-a). Here, the ratio can be a<b<c<d. For example, the ratio is set to be a=10%, b=20%, c=30%, and d=40%, but is not necessarily limited thereto.

In the embodiment, power consumption can be reduced through the second section where the second bias current is applied.

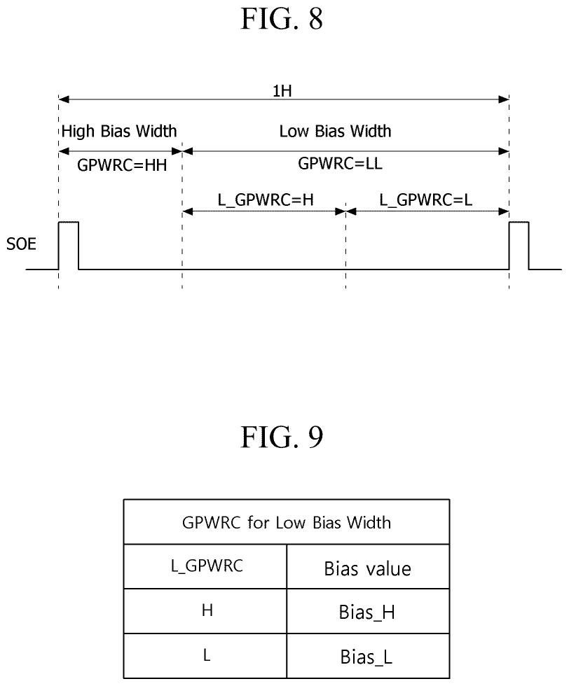

Referring to FIGS. 8 and 9, one-bit first-first power control information L_GPWRC can be added, the second section can be divided into a second-first section and a second-second section, and different bias currents can be applied to the buffers for the second-first section and the second-second section. For example, when the first-first power control information L_GPWRC is ‘H’, a bias current Bias_H with a second magnitude can be applied for the second-first section, and a bias current Bias_L with a third magnitude smaller than the second magnitude can be applied for the second-second section.

A reason is to prepare for an unexpected situation that can occur when a lowest bias current is applied for the second section occupying most time of 1H.

The buffers B can output predetermined output voltages on the basis of the applied bias current. Each of the buffers B can include an input circuit IST and an output circuit OST. The input circuit IST can amplify the input voltage Vin and can output an amplified voltage. The output circuit OST can output an output voltage Vout using the amplified voltage from the input circuit IST. For example, the buffers B can include a first buffer part BUF1 and a second buffer part BUF2 of FIG. 4, the first buffer part BUF1 outputs a reference voltage as an output voltage, and the second buffer part BUF2 outputs a gamma reference voltage as an output voltage.

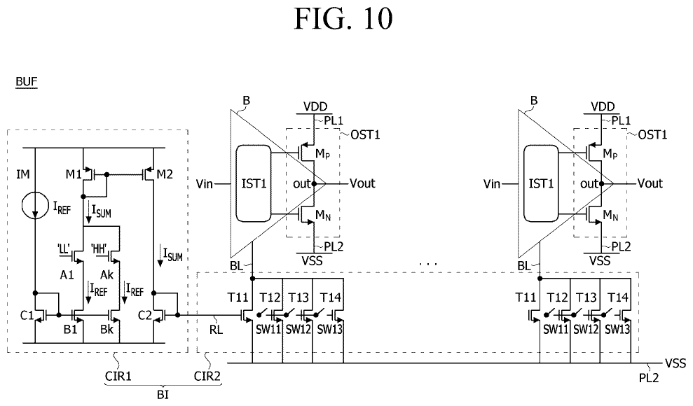

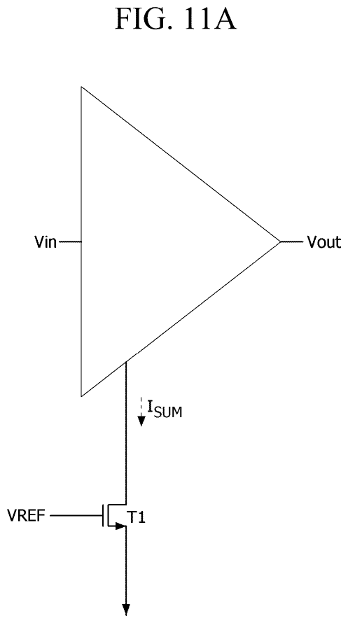

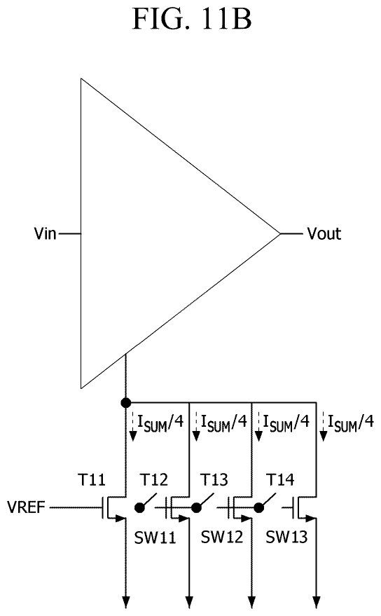

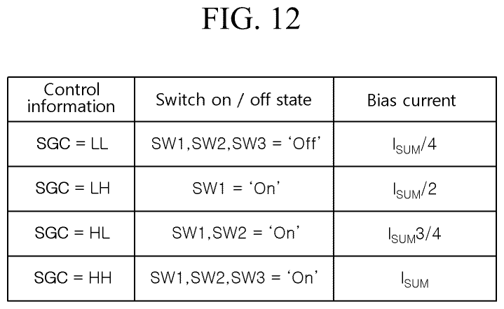

FIG. 10 is a diagram illustrating a detailed configuration of a first buffer part according to a second embodiment of the present disclosure, and FIGS. 11A, 11B, and 12 are diagrams illustrating an operation principle of a first buffer for comparison.

Referring to FIG. 10, a buffer part BUF according to a second embodiment of the present disclosure can include a bias part BI and buffers B.

The bias part BI can apply a bias current to the buffers B. The bias part BI can include a first circuit part CIR1 and a second circuit part CIR2. The first circuit part CIR1 can generate a bias current with a magnitude determined according to power control information.

The second circuit part CIR2 can apply the bias current to each buffer B, and specifically, can apply different bias currents according to the output voltages of the buffers B. The second circuit part CIR2 can include a plurality of transistors T11, T12, T13, and T14 and a plurality of switches SW11, SW12, and SW13).

The plurality of transistors T11, T12, T13, and T14 can include an eleventh transistor T11, a twelfth transistor T12, a thirteenth transistor T13, and a fourteenth transistor fourteenth transistor T14. The plurality of transistors T11, T12, T13, and T14 can be connected in parallel between a first line BL to which the bias current is applied and a second power line PL2 to which a low-potential voltage VSS is applied. Each of the plurality of transistors T11, T12, T13, and T14 includes a gate electrode connected to a second line RL to which a reference bias current is applied, a first electrode that applies the bias current to the buffer connected to the first line BL, and a second electrode connected to the second power line PL2.

The plurality of switches can include an eleventh switch SW11, a twelfth switch SW12, and a thirteenth switch SW13. The eleventh switch SW11 is connected between the gate electrode of the eleventh transistor T11 and the gate electrode of the twelfth transistor T12, the twelfth switch SW12 is connected between the gate electrode of the twelfth transistor T12 and the gate electrode of the thirteenth transistor T13, and the thirteenth switch SW13 is connected between the gate electrode of the thirteenth transistor T13 and the gate electrode of the fourteenth transistor T14.

The eleventh switch SW11, the twelfth switch SW12, and the thirteenth switch SW13 can be selectively turned on according to the output voltage of the buffer. For example, as the output voltage of the buffer is higher, the number of switches that are turned on becomes greater, and otherwise, the number of switches that are turned on becomes smaller.

For example, when the output voltage of the buffer is a first voltage, all of the eleventh switch SW11, the twelfth switch SW12, and the thirteenth switch SW13 are turned on, when the output voltage of the buffer is a second voltage lower than the first voltage, the eleventh switch SW11 and the twelfth switch SW12 are turned on and the thirteenth switch SW13 is turned off, when the output voltage of the buffer is a third voltage lower than the second voltage, the eleventh switch SW11 is turned on and the twelfth switch SW12 and the thirteenth switch SW13 are turned off, and when the output voltage of the buffer is a fourth voltage lower than the third voltage, all of the eleventh switch SW11, the twelfth switch SW12, and the thirteenth switch SW13 are turned off.

The buffers B can output a predetermined output voltage according to the applied bias current. Each of the buffers B can include a first input circuit IST1 and a first output circuit OST1.

The first input circuit IST1 can amplify an input voltage Vin and can output amplified positive polarity and negative polarity voltages.

The first output circuit OST1 can output a reference voltage Vout using the amplified voltage. The first output circuit OST1 can include a pull-up transistor Mp and a pull-down transistor Mn. The pull-up transistor Mp and the pull-down transistor Mn can be turned on according to the amplified voltage. The pull-up transistor Mp includes a gate electrode to which the amplified voltage is applied, a first electrode connected to a first power line PL1 to which a high-potential voltage VDD is applied, and a second electrode connected to an output node. The pull-down transistor Mn includes a gate electrode to which the amplified voltage is applied, a first electrode connected to the output node, and a second electrode connected to a second power line PL2 to which a low-potential voltage VSS is applied.

The first output circuit OST1 can adjust a voltage level of an output voltage Vout that is output via the output node according to a voltage level of the amplified voltage. The voltage level of the output voltage Vout can be adjusted between the high-potential voltage VDD and the low-potential voltage VSS.

When the second circuit part CIR2 is configured with a single transistor as in FIG. 11A, a current Isum with a fixed magnitude is consumed; however, when the second circuit part CIR2 is configured with a plurality of transistors as in FIG. 11B, a current Isum/4*n (where n=1, 2, 3, 4) can be consumed by selectively driving the transistors. To this end, transistors T11, T12, T13, and T14 of FIG. 11B can be designed to have a size of ¼ compared to the size of the transistor T1 of FIG. 11A, and accordingly, the transistors T11, T12, T13, and T14 can have a channel capacity of ¼ compared to the channel capacity of the transistor T1.

When the second power control information SGC is ‘LL’ as in FIG. 12, all of the eleventh to thirteenth switches SW11, SW12, and SW13 are turned off and the bias current becomes Isum/4, when the second power control information SGC is ‘LH’, the eleventh switch SW11 is turned on and the bias current becomes Isum/2, when the second power control information SGC is ‘HL’, the eleventh and twelfth switches SW11 and SW12 are turned on and the bias current becomes Isum×¾, and when the second power control information SGC is ‘HH’, all of the eleventh to thirteenth switches SW11, SW12, and SW13 are turned on and the bias current becomes Isum.

In this case, the second power control information SGC can vary depending on an output voltage of a gamma buffer. For example, when the output voltage of the gamma buffer is relatively large, the bias current can be adjusted to be large, and when the output voltage of the gamma buffer is relatively small, the bias current can be adjusted to be small. Referring to FIG. 4, the output voltage of the gamma buffer can be made small in an order of a first buffer that outputs a gamma reference voltage VGMA1, a second buffer that outputs a gamma reference voltage VGMA2, a second buffer that outputs a gamma reference voltage VGMA3, a second buffer that outputs a gamma reference voltage VGMA4, a second buffer that outputs a gamma reference voltage VGMA5, a second buffer that outputs a gamma reference voltage VGMA6, and a first buffer that outputs a gamma reference voltage VGMA7. Accordingly, the bias currents of the respective gamma buffers can be adjusted to be different according to the gamma reference voltages VGMA1 to VGMA7 that are the output voltages of the gamma buffers.

In the embodiment, while a case where the second circuit part CIR2 is configured with four transistors has been described as an example, the present disclosure is not necessarily limited thereto, and the second circuit part CIR2 can be configured with, for example, two or more transistors.

For example, when the number of first buffers B1 is five, and the second circuit part CIR2 is configured with one transistor, current consumption of Isum×5 is generated; however, as in the embodiment, when the second circuit part CIR2 is configured with four transistors, current consumption of Isum/4×5=Isum×1.25 is generated. From this, it can be understood that current consumption is reduced to about 25%.

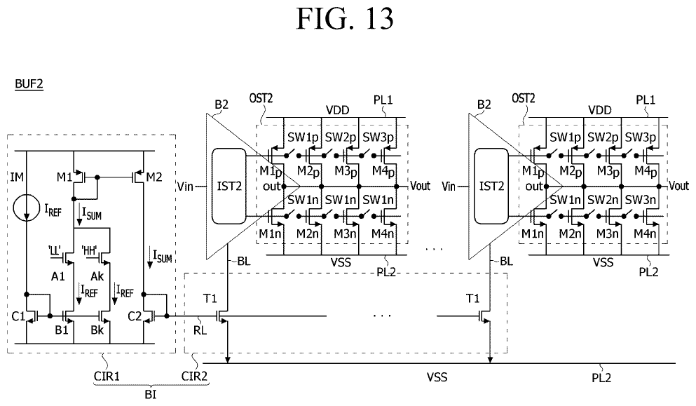

FIG. 13 is a diagram illustrating a detailed configuration of a second buffer part according to a third embodiment of the present disclosure.

Referring to FIG. 13, a second buffer part BUF2 according to a third embodiment of the present disclosure can include a bias part BI and second buffers B2.

The bias part BI can apply a bias current to the second buffers B2. The bias part BI can include a first circuit part CIR1 and a second circuit part CIR2. The first circuit part CIR1 can generate a bias current with a magnitude determined according to power control information.

The second circuit part CIR2 can apply a bias current to each second buffer B2. The second circuit part CIR2 can include a transistor T1 connected to each second buffer B2.

Each of the second buffers B2 can output an output voltage Vout according to the applied bias current. Each of the second buffers B2 can include a second input circuit IST2 and a second output circuit OST2.

The second input circuit IST2 can amplify an input voltage Vin and can output amplified positive polarity and negative polarity voltages.

The second output circuit OST2 can output the output voltage Vout using the amplified voltage. The second output circuit OST2 can include a plurality of pull-up transistors M1p, M2p, M3p, and M4p and pull-down transistors M1n, M2n, M3n, and M4n and a plurality of pull-up switches SW1p, SW2p, and SW3p and pull-down switches SW1n, SW2n, and SW3n.

The plurality of pull-up transistors M1p, M2p, M3p, and M4p can include a first pull-up transistor M1p, a second pull-up transistor M2p, a third pull-up transistor M3p, and a fourth pull-up transistor M4p. The plurality of pull-up transistors M1p, M2p, M3p, and M4p can be connected in parallel between a first power line PL1 to which a high-potential voltage VDD is applied and an output node OUT.

The plurality of pull-down transistors M1n, M2n, M3n, and M4n can include a first pull-down transistor M1n, a second pull-down transistor M2n, a third pull-down transistor M3n, and a fourth pull-down transistor M4n. The plurality of pull-down transistors M1n, M2n, M3n, and M4n can be connected in parallel between the output node OUT and a second power line PL2 to which a low-potential voltage VSS is applied.

The plurality of pull-up switches SW1p, SW2p, and SW3p can include a first pull-up switch SW1p, a second pull-up switch SW2p, and a third pull-up switch SW3p. The first pull-up switch SW1p is connected between a gate electrode of the first pull-up transistor M1p and a gate electrode of the second pull-up transistor M2p, the second pull-up switch SW2p is connected between the gate electrode of the second pull-up transistor M2p and a gate electrode of the third pull-up transistor M3p, and the third pull-up switch SW3p is connected between the gate electrode of the third pull-up transistor M3p and a gate electrode of the fourth pull-up transistor M4p.

The plurality of pull-down switches SW1n, SW2n, and SW3n can include a first pull-down switch SW1n, a second pull-down switch SW2n, and a third pull-down switch SW3n. The first pull-down switch SW1n is connected between a gate electrode of the first pull-down transistor M1n and a gate electrode of the second pull-down transistor M2n, the second pull-down switch SW2n is connected between the gate electrode of the second pull-down transistor M2n and a gate electrode of the third pull-down transistor M3n, and the third pull-down switch SW3n is connected between the gate electrode of the third pull-down transistor M3n and a gate electrode of the fourth pull-down transistor M4n.

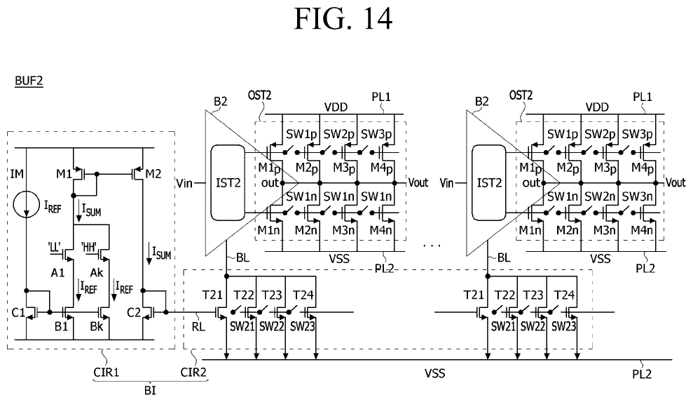

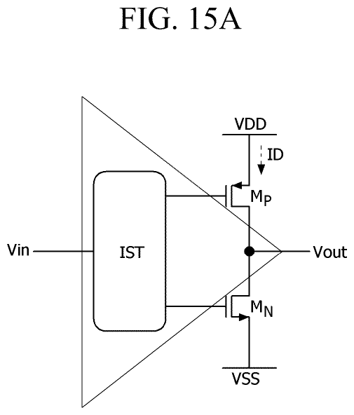

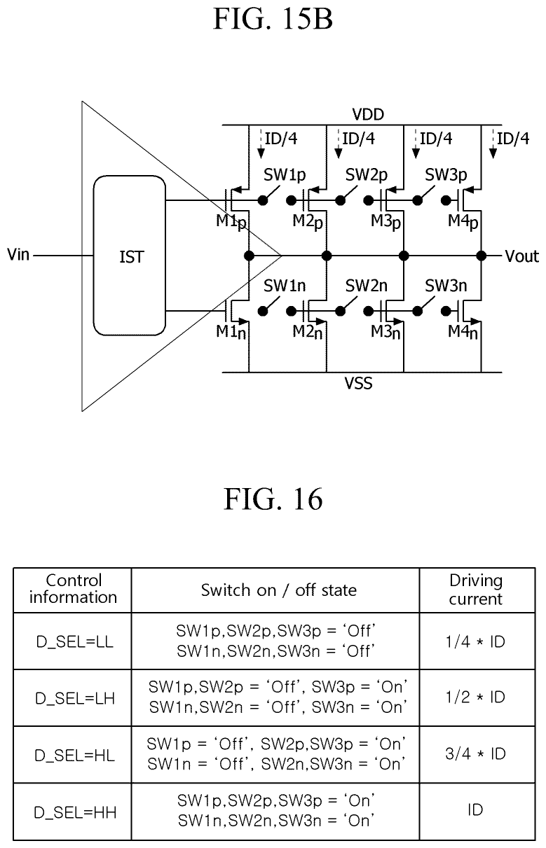

FIG. 14 is a diagram illustrating a detailed configuration of a second buffer part according to a fourth embodiment of the present disclosure, and FIGS. 15A, 15B, and 16 are diagrams illustrating an operation principle of a second buffer for comparison.

Referring to FIG. 14, a second buffer part BUF2 according to a fourth embodiment of the present disclosure can include a bias part BI and second buffers B2.

The bias part BI can apply a bias current to the second buffers B2. The bias part BI can include a first circuit part CIR1 and a second circuit part CIR2. The first circuit part CIR1 can generate a bias current with a magnitude determined according to power control information.

The second circuit part CIR2 can apply a bias current to each second buffer B2, and specifically, can apply different bias currents to the second buffers B2 according to driving voltages of the respective second buffers B2. The second circuit part CIR2 can include a plurality of transistors T11, T12, T13, and T14 and a plurality of switches SW11, SW12, and SW13.

The plurality of transistors T21, T22, T23, and T24 can include a twenty-first transistor T21, a twenty-second transistor T22, a twenty-third T23, and a twenty-fourth transistor T24. The plurality of transistors T21, T22, T23, and T24 can be connected in parallel between a first line BL to which the bias current is applied and a second power line PL2 to which a low-potential voltage VSS is applied. Each of the plurality of transistors T21, T22, T23, and T24 includes a gate electrode connected to a second line RL to which a reference current is applied, a first electrode connected to the first line BL, and a second electrode connected to the second power line PL2.

The plurality of switches can include a twenty-first switch SW21, a twenty-second switch SW22, and a twenty-third switch SW23. The twenty-first switch SW21 is connected between the gate electrode of the twenty-first transistor T21 and the gate electrode of the twenty-second transistor T22, the twenty-second switch SW22 is connected between the gate electrode of the twenty-second transistor T22 and the gate electrode of the twenty-third transistor T23, and the twenty-third switch SW23 is connected between the gate electrode of the twenty-third transistor T23 and the gate electrode of the twenty-fourth transistor T24.

The twenty-first switch SW21, the twenty-second switch SW22, and the twenty-third SW23 can be selectively turned on according to the output voltage of the first buffer. For example, as the output voltage of the first buffer is higher, the number of switches that are turned on becomes greater, and otherwise, the number of switches that are turned on becomes smaller.

The second buffers B2 can output an output voltage Vout according to the applied bias current. Each of the second buffers B2 can include a second input circuit IST2 and a second output circuit OST2.

The second input circuit IST2 can amplify an input voltage Vin to output amplified positive polarity and negative polarity voltages.

The second output circuit OST2 can output the output voltage Vout using the amplified voltage. The second output circuit OST2 can include a plurality of pull-up transistors M1p, M2p, M3p, and M4p and pull-down transistors M1n, M2n, M3n, and M4n and a plurality of pull-up switches SW1p, SW2p, and SW3p and pull-down switches SW1n, SW2n, and SW3n.

The plurality of pull-up transistors M1p, M2p, M3p, and M4p can include a first pull-up transistor M1p, a second pull-up transistor M2p, a third pull-up transistor M3p, and a fourth pull-up transistor M4p. The plurality of pull-up transistors M1p, M2p, M3p, and M4p can be connected in parallel between a first power line PL1 to which a high-potential voltage VDD is applied and an output node OUT.

The plurality of pull-down transistors M1n, M2n, M3n, and M4n can include a first pull-down transistor M1n, a second pull-down transistor M2n, a third pull-down transistor M3n, and a fourth pull-down transistor M4n. The plurality of pull-down transistors M1n, M2n, M3n, and M4n can be connected in parallel between the output node OUT and a second power line PL2 to which a low-potential voltage VSS is applied.

The plurality of pull-up switches SW1p, SW2p, and SW3p can include a first pull-up switch SW1p, a second pull-up switch SW2p, and a third pull-up switch SW3p. The first pull-up switch SW1p is connected between a gate electrode of the first pull-up transistor M1p and a gate electrode of the second pull-up transistor M2p, the second pull-up switch SW2p is connected between the gate electrode of the second pull-up transistor M2p and a gate electrode of the third pull-up transistor M3p, and the third pull-up switch SW3p is connected between the gate electrode of the third pull-up transistor M3p and a gate electrode of the fourth pull-up transistor M4p.

The plurality of pull-down switches SW1n, SW2n, and SW3n can include a first pull-down switch SW In, a second pull-down switch SW2n, and a third pull-down switch SW3n. The first pull-down switch SW In is connected between a gate electrode of the first pull-down transistor M1n and a gate electrode of the second pull-down transistor M2n, the second pull-down switch SW2n is connected between the gate electrode of the second pull-down transistor M2n and a gate electrode of the third pull-down transistor M3n, and the third pull-down switch SW3n is connected between the gate electrode of the third pull-down transistor M3n and a gate electrode of the fourth pull-down transistor M4n.

When each of the second buffers B2 is configured with only a pair of transistors as in FIG. 15A, a current ID with a fixed magnitude is consumed; however, as in FIG. 15B, when the second buffers B2 is configured with a plurality of pairs of transistors, a current ID/4*n (where n=1, 2, 3, 4) with a variable magnitude can be consumed by selectively driving the transistors. To this end, the transistors M1p/M1n, M2p/M2n, M3p/M3n, and M4p/M4n of FIG. 15B can be designed to have a size of ¼ compared to the size of the transistor Mp/Mn of FIG. 15A.

Referring to FIG. 16, when the third power control information D_SEL is ‘LL’, all of first to third pull-up switches SW1p, SW2p, and SW3p and first to third pull-down switches SW1n, SW2n, and SW3n are turned off and a driving current becomes ID/4, when the third power control information D_SEL is ‘LH’, the third pull-up switch SW1p and the third pull-down switch SW1n are turned on and the driving current becomes ID/2, when the third power control information D_SEL is ‘HL’, the second and third pull-up switches SW2p and SW3p and the second and third pull-down switches SW2n and SW3n are turned on and the driving current becomes ID*¾, and when the third power control information D_SEL is ‘HH’, all of the first to third pull-up switches SW1p, SW2p, and SW3p and the first to third pull-down switches SW1n, SW2n, and SW3n are turned on and the driving current becomes ID.

In this case, the third power control information D_SEL can be set in advance according to the load of the display panel. For example, when the load of the display panel is large, the driving current can be determined to be large, and when the load of the display panel is small, the driving current can be determined to be small.

In the embodiment, while a case where a pair of transistors is provided has been described as an example, for example, two or more pairs of transistors can be provided.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gamma voltage generating circuit comprising:
a plurality of first buffers each configured to receive first and second reference voltages supplied from a power supply;
a first resistor string configured to divide the first and second reference voltages applied from the plurality of first buffers;
a plurality of second buffers configured to output a plurality of predetermined gamma reference voltages based on divided voltages from the first resistor string; and
a second resistor string configured to generate a plurality of predetermined gamma voltages by dividing the plurality of predetermined gamma reference voltages output from the plurality second buffers,
wherein a bias current with a first magnitude is supplied to at least one of the plurality of first buffers and the plurality of second buffers for a first section of a horizontal period, and
wherein a bias current with a second magnitude smaller than the first magnitude is supplied to at least one of the plurality of first buffers and the plurality of second buffers for a second section of the horizontal period.

2. The gamma voltage generating circuit according to claim 1, wherein the first section of the horizontal period is determined at a predetermined ratio according to a load of a display panel.

3. The gamma voltage generating circuit according to claim 2, wherein the first section of the horizontal period is determined at a predetermined ratio with a rising time of a source output enable (SOE) signal as a reference.

4. The gamma voltage generating circuit according to claim 1, wherein the second section of the horizontal period includes:
a second-first section where the bias current with the second magnitude is supplied, and
a second-section section where a bias current with a third magnitude smaller than the second magnitude is supplied.

5. The gamma voltage generating circuit according to claim 1, further comprising:
a bias part configured to generate a bias current to be applied to the plurality of first and second buffers,
wherein the bias part includes:
n transistors each having a gate electrode to which the generated bias current is applied, a first electrode connected to the first and second buffers, and a second electrode connected to a power line to which a low-potential voltage, where n is a natural number greater than one; and
m switches connected between the gate electrodes of the n transistors, where m is a natural number.

6. The gamma voltage generating circuit according to claim 1, wherein each of the plurality of second buffers includes:
an input circuit configured to amplify an input voltage and output a positive polarity voltage and a negative polarity voltage;
n pull-up transistors each having a gate electrode to which the positive polarity voltage is applied, a first electrode connected to a power line to which a high-potential voltage is applied, and a second electrode connected to an output terminal, where n is a natural number greater than one;
m pull-up switches connected between the gate electrodes of the n pull-up transistors, where m is a natural number;
n pull-down transistors each having a gate electrode to which the negative polarity voltage is applied, a first electrode connected to the output terminal, and a second electrode connected to a power line to which a low-potential voltage is applied; and
m pull-down switches connected between the gate electrodes of the n pull-down transistors.

7. A gamma voltage generating circuit comprising:
a plurality of first buffers each configured to receive first and second reference voltages supplied from a power supply;
a first resistor string configured to divide the first and second reference voltages applied from the plurality of first buffers;
a plurality of second buffers configured to output a plurality of predetermined gamma reference voltages based on divided voltages from the first resistor string;
a second resistor string configured to generate a plurality of predetermined gamma voltages by dividing the plurality of predetermined gamma reference voltages output from the plurality of second buffers; and
a bias part configured to generate a bias current to be applied to the plurality of first and second buffers,
wherein the bias part supplies a bias current with a first magnitude to at least one of the plurality of first and second buffers for a first section of a horizontal period, and supplies a bias current with a second magnitude smaller than the first magnitude to at least one of the plurality of first and second buffers for a second section of the horizontal period.

8. The gamma voltage generating circuit according to claim 7, wherein the bias part includes:
n transistors each having a gate electrode to which the generated bias current is applied, a first electrode connected to the first and second buffers, and a second electrode connected to a power line to which a low-potential voltage is applied, where n is a natural number greater than one; and
m switches connected between the gate electrodes of the n transistors, where m is a natural number.

9. The gamma voltage generating circuit according to claim 7, wherein each of the second buffers includes:
an input circuit configured to amplify an input voltage and output a positive polarity voltage and a negative polarity voltage;
n pull-up transistors each having a gate electrode to which the positive polarity voltage is applied, a first electrode connected to a power line to which a high-potential voltage is applied, and a second electrode connected to an output terminal, where n is a natural number greater than one;
m pull-up switches connected between the gate electrodes of the n pull-up transistors, where m is a natural number;
n pull-down transistors each having a gate electrode to which the negative polarity voltage is applied, a first electrode connected to the output terminal, and a second electrode connected to a power line to which a low-potential voltage is applied, and
m pull-down switches connected between the gate electrodes of the n pull-down transistors.

10. The gamma voltage generating circuit according to claim 9, wherein the number of switches that are turned on among the m pull-up switches and the m pull-down switches is determined in advance according to a magnitude of an output voltage of each of the second buffers.

11. A display device comprising:
a pixel array in which a plurality of data lines, a plurality of gate lines, and a plurality of pixel circuits are disposed;
a data driver configured to output a data voltage generated using a gamma voltage to the plurality of data lines;
a gate driver configured to output a gate signal to the plurality of gate lines; and
a timing controller configured to control the data driver and the gate driver,
wherein the data driver includes a gamma voltage generating circuit configured to generate a gamma voltage,
wherein the gamma voltage generating circuit includes:
a plurality of first buffers each configured to receive first and second reference voltages supplied from a power supply;
a first resistor string configured to divide the first and second reference voltages applied from the plurality of first buffers;
a plurality of second buffers configured to output a plurality of predetermined gamma reference voltages based on divided voltages from the first resistor string;
a second resistor string configured to generate a plurality of predetermined gamma voltages by dividing the plurality of predetermined gamma reference voltages output from the plurality of second buffers; and
a bias part configured to generate a bias current to be applied to the plurality of first and second buffers, and
wherein a bias current with a first magnitude is supplied to the plurality of first and second buffers for a first section of a horizontal period, and a bias current with a second magnitude smaller than the first magnitude is supplied to the plurality of first and second buffers for a second section of the horizontal period.

12. The display device according to claim 11, wherein the timing controller is configured to transmit, to the data driver, a data packet including power control information for determining the first section and the second section of the horizontal period.

13. The display device according to claim 12, wherein the first section of the horizontal period is determined at a predetermined ratio according to a load of a display panel including the pixel array.

14. The display device according to claim 13, wherein the first section of the horizontal period is determined at a predetermined ratio with a rising time of a source output enable (SOE) signal as a reference.

15. The display device according to claim 12, wherein the second section of the horizontal period includes:
a second-first section where the bias current with the second magnitude is supplied, and
a second-section section where a bias current with a third magnitude smaller than the second magnitude is supplied.

16. A display device comprising:
a pixel array in which a plurality of data lines, a plurality of gate lines, and a plurality of pixel circuits are disposed;
a data driver configured to output a data voltage generated using a gamma voltage to the plurality of data lines;
a gate driver configured to output a gate signal to the plurality of gate lines; and
a timing controller configured to control the data driver and the gate driver,
wherein the data driver includes a gamma voltage generating circuit configured to generate a gamma voltage,
wherein the gamma voltage generating circuit includes:
a plurality of first buffers each configured to receive first and second reference voltages supplied from a power supply;
a first resistor string configured to divide the first and second reference voltages applied from the plurality of first buffers;
a plurality of second buffers configured to output a plurality of predetermined gamma reference voltages based on divided voltages from the first resistor string;
a second resistor string configured to generate a plurality of predetermined gamma voltages by dividing the plurality of predetermined gamma reference voltages output from the plurality of second buffers; and
a bias part configured to generate a bias current to be applied to the plurality of first and second buffers, and
wherein the bias part includes:
n transistors each having a gate electrode to which the generated bias current is applied, a first electrode connected to the first and second buffers, and a second electrode connected to a power line to which a low-potential voltage is applied, where n is a natural number greater than one; and
m switches connected between the gate electrodes of the n transistors, where m is a natural number.

17. The display device according to claim 16, wherein the timing controller is configured to transmit, to the data driver, a data packet including power control information for controlling the bias current to be applied to each of the plurality of first and second buffers.

18. The display device according to claim 16, wherein each of the plurality of second buffers includes:
an input circuit configured to amplify an input voltage and output a positive polarity voltage and a negative polarity voltage;
n pull-up transistors each having a gate electrode to which the positive polarity voltage is applied, a first electrode connected to a power line to which a high-potential voltage is applied, and a second electrode connected to an output terminal, where n is a natural number greater than one;
pull-up switches connected between the gate electrodes of the n pull-up transistors;
n pull-down transistors each having a gate electrode to which the negative polarity voltage is applied, a first electrode connected to the output terminal, and a second electrode connected to a power line to which a low-potential voltage is applied; and
m pull-down switches connected between the gate electrodes of the n pull-down transistors, where m is a natural number.

19. The display device according to claim 18, wherein the timing controller is configured to transmit, to the data driver, a data packet including power control information for controlling a driving current of the plurality of second buffers.

20. The display device according to claim 18, wherein the number of switches that are turned on among the m pull-up switches and the m pull-down switches is determined in advance according to a magnitude of an output voltage of each of the plurality of second buffers.
